(19) United States
(12) Patent Application Publication
(10) Pub. No.: US 2016/0225017 A1
(43) Pub. Date: Aug. 4, 2016

(54) SIZE OF PRIZE PREDICTIVE MODEL

(71) Applicant: Linkedln Corporation, Mountain View, CA (US)

(72) Inventors: Jimmy K. Wong, San Mateo, CA (US); Yan Liu, Sunnyvale, CA (US)

(21) Appl. No.: 14/609,493

(22) Filed: Jan. 30, 2015

(51) Int. Cl. G06Q 30/02; G06N 99/00; G06N 5/04; G06Q 10/06; G06Q 50/00

(52) U.S. Cl. CPC G06Q 30/0247; G06Q 10/067; G06Q 50/01; G06N 5/04; G06N 99/005

(57) ABSTRACT

A machine may be configured to determine a predicted share of an online advertising budget to be spent by a company on a marketing product or service provided by a social networking service, in a period of time. For example, the machine performs a revenue prediction modeling process to generate a revenue-per-employee value that represents a predicted revenue amount per employee of a company for a period of time. The machine performs an advertising spend prediction modeling process to generate an advertising-per-employee value that represents a predicted online advertising spending amount per employee of the company in the period of time. The machine performs a share prediction modeling process to generate a sales-per-employee value that represents a predicted share of the advertising-per-employee value to be spent by the company on a marketing product or service provided by a social networking service, in the period of time.

### TECHNICAL FIELD

The present application relates generally to the processing of data, and, in various example embodiments, to systems, methods, and computer program products for determining a predicted share of an online advertising budget to be spent by a company on a marketing product or service provided by a social networking service, in a period of time.

### BACKGROUND

Traditionally, a sales person may prioritize sales leads (or potential customers) before the sales person makes a sales call. Examples of factors that may influence the prioritizing of the sales leads are whether the sales person is acquainted with anyone employed by a potential customer, whether the potential customer requested information relevant to a product or service for sale, or whether a call to the potential customer is scheduled.

However, the frequent lack of sufficient information about the entities that are potential customers may make this traditional sales approach ineffective. For example, contacting a potential customer that is not ready to purchase a product or service, or offering a product or service that is of no interest to a potential customer is wasteful of resources.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2 is a block diagram illustrating components of a prediction modelling system, according to some example embodiments;

FIG. 3 is a flowchart illustrating a method of determining a predicted revenue amount per employee of a company for a period of time, according to some example embodiments;

FIG. 4 is a flowchart illustrating a method of determining a predicted online advertising spending amount per employee of a company in a period of time, according to some example embodiments;

FIG. 5 is a flowchart illustrating a method of determining a predicted share of an advertising-per employee value to be spent by a company on a marketing product or service provided by a social networking service in a period of time, according to some example embodiments;

FIG. 6 is a flowchart illustrating a method of determining a predicted revenue amount per employee of a company for a period of time, and representing the step 304 of the method illustrated in FIG. 3 in more detail, according to some example embodiments;

FIG. 7 is a flowchart illustrating a method of determining a predicted revenue amount per employee of a company for a period of time, and representing an additional step and step 304 of the method illustrated in FIG. 3 in more detail, according to some example embodiments;

FIG. 8 is a flowchart illustrating a method of determining a predicted online advertising spending amount per employee of a company in a period of time, and representing an additional step and step 404 of the method illustrated in FIG. 4 in more detail, according to some example embodiments;

FIG. 9 is a flowchart illustrating a method of determining a predicted share of an advertising-per employee value to be spent by a company on a marketing product or service provided by a social networking service in a period of time, and representing an additional step and step 504 of the method illustrated in FIG. 5 in more detail, according to some example embodiments;

FIG. 10 is a flowchart illustrating a method of determining a predicted share of an advertising-per employee value to be spent by a company on a marketing product or service provided by a social networking service in a period of time, and representing an additional step of the method illustrated in FIG. 5, according to some example embodiments;

FIG. 11 is a flowchart illustrating a method of determining a predicted share of an advertising-per employee value to be spent by a company on a marketing product or service provided by a social networking service in a period of time, and representing an additional step of the method illustrated in FIG. 10, according to some example embodiments;

FIG. 12 is a flowchart illustrating a method of determining a predicted share of an advertising-per employee value to be spent by a company on a marketing product or service provided by a social networking service in a period of time, and representing an additional step of the method illustrated in FIG. 11, according to some example embodiments;

FIG. 13 is a flowchart illustrating a method of determining a predicted share of an advertising-per employee value to be spent by a company on a marketing product or service provided by a social networking service in a period of time, and representing additional steps of the method illustrated in FIG. 10, according to some example embodiments;

FIG. 14 is a block diagram illustrating a mobile device, according to some example embodiments; and

FIG. 15 is a block diagram illustrating components of a machine, according to some example embodiments, able to read instructions from a machine-readable medium and perform any one or more of the methodologies discussed herein.

### DETAILED DESCRIPTION

Example methods and systems for determining a predicted share of an online advertising budget to be spent by a company on a marketing product or service provided by a social networking service in a period of time are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

According to some example embodiments, a social networking service (e.g., LinkedIn®, hereinafter also “LinkedIn”) may facilitate the establishing of social networks among different entities, such as people who are members of the social networking service, organizations registered with the social networking service, groups, etc. The social networking service (also “SNS”) may store various types of data regarding the entities.

In some example embodiments, a prediction modelling system may analyze various types of data associated with one or more organizations (e.g., public, private, commercial, non-profit, public sector, U.S. or international entities) and predict the “share of prize” (also “share of wallet” or share of online advertising budget) that a particular organization (hereinafter also “company”) is likely to spend on a product or service offered for sale by another organization (e.g., a social networking service such as LinkedIn®). In some instances, the analysis of the various types of data associated with the one or more organizations includes inferring (or predicting) business information about the revenue structure and advertising budget of the one or more organizations. For example, the predicting, by the prediction modelling system, of the share of prize associated with a company may be based on proprietary member and company data maintained by the SNS, or external publicly available data, or both. The methodology and algorithms supporting the prediction modelling system are independent of the type of product, service, or business unit involved.

The prediction modelling system may also facilitate the prioritizing of sales leads associated with a plurality of companies based on the predicted shares of online advertising amounts to be spent by the plurality of companies on a product or service provided by the SNS in a period of time. This prioritizing may allow the sales and marketing teams of the SNS to increase their success rate in acquiring and growing customers. Additionally or alternatively, the prediction modelling system may be adapted into monetizable products for external customers.

In some example embodiments, the prediction modelling system predicts the annual revenue for a company, the proportion of the annual revenue to be spent by the company on digital media, and the proportion of a digital media spend likely to be spent on products or services offered by the SNS, based on one or more prediction models and certain input data. In some instances, the input data received by the prediction modelling system is collected from external public data sources, such as the U.S. Security and Exchange Commission's EDGAR database, U.S. Census data, or World Bank data. Additional input data may include aggregated member demographics data, maintained by the SNS, such as identifiers of skills of members of the SNS, zip codes associated with member locations, member education, web browser usage on the SNS, company profiles, engagement data on the SNS by members or representatives of the companies, etc.

Some of the input data regarding the company may be acquired based on examining the HyperText Markup Language (also “HTML”) source code of the website(s) associated with a particular company to identify information such as usage of ad retargeting tags, web analytics systems, or social media presence. Based on this information, the prediction modelling system may derive an indicator of a marketing sophistication level associated with the company. The indicator of a marketing sophistication level may be a numerical value. The higher this numerical value, the more sophisticated the company with respect to social media and digital advertising. Additionally, publicly available data pertaining to the revenue or advertising spend for one or more companies, or proprietary data pertaining to previous sales transactions between the one or more companies and the SNS may be used to calibrate the prediction models of the prediction modelling system.

The additional input data pertaining to members of the SNS helps distinguish members who are employees of certain companies and who are already aware of and educated about social media and digital advertising. Similarly, member activity and behavior with respect to the SNS (e.g., selecting or clicking on certain digital content displayed on a SNS website) is indicative of member interests. In some example embodiments, the prediction modelling system may derive an indicator of a digital marketing skill level for one or more member employees of a company based on the digital marketing and social media skills associated with the one or more employees. The indicator of the digital marketing skill may be a numerical value. The higher this numerical value, the more sophisticated the member employee in digital marketing.

It may be reasonable to infer that companies that employ people who have a certain degree of marketing sophistication (e.g., have and/or list social media and digital advertising skills in their SNS member profiles) are more likely to purchase products or services provided by the SNS (e.g., digital advertising products or services). Further, the higher the indicators of digital marketing skill levels of one or more member employees and the indicator of the marketing sophistication level of the company that employs the one or more member employees, the more likely it is that the company will purchase products or service provided by the SNS, and thus the higher the revenue-per-employee value, the advertising-per-employee value, and the sales-per employee value associated with the company.

The sales people selling products or services offered by the SNS may find it easier to sell to a company that invests in hiring people with certain social media and digital advertising skills, or in providing training in these areas. The one or more prediction models can take into account member profile data (e.g., various skills), member activity and behavior data, the indicator of a marketing sophistication level associated with the company, indicators of the digital marketing skills of one or more member employees, as well as historical data pertaining to interactions by representatives of the company with the SNS (e.g., previous purchases by the company of products or services provided by the SNS) to identify the company more likely to purchase products or service offered by the SNS (e.g., LinkedIn Marketing Solutions). Further, the additional input data in combination with other data may serve as input to the one or more prediction models of the prediction modelling system for predicting the annual revenue for the company, the proportion of the annual revenue to be spent by the company on digital media, and the proportion of the digital media spend likely to be spent on products or services offered by the SNS.

In some example embodiments, the prediction models of the prediction modelling system are trained based on various input data. The input training data is fitted via a regression algorithm (e.g., a Random Forest regression algorithm) and then post-processed with a linear regression algorithm to boost the accuracy of the results. The methodology associated with the prediction modelling system may permit the rapid iteration of additional models as well as optimization of current models.

### Revenue Prediction

According to certain example embodiments, the prediction modelling system predicts the annual revenue of a company, with proper estimates allocated to subsidiary companies without double-counting the annual revenue at each subsidiary company level, based on a revenue prediction model. The company, or one or more subsidiaries of the company, may be an entity that has a presence on the SNS as a result of registering with the SNS. The revenue prediction model may be utilized to predict, for one or more companies (or subsidiaries), the revenue-per-employee value that represents a predicted revenue amount per employee of the company (or the subsidiary) for a period of time.

In some example embodiments, the prediction modelling system first trains the revenue prediction model based on a first training data set. The first training data set may be generated based on the public 10-Q financial filings obtained from the U.S. SEC (e.g., the Edgar website) of all U.S. publicly traded companies. A computer program may be generated to parse the SEC financial filings to obtain the quarterly revenue amounts for a particular period of time (e.g., the past 8 quarters), for one or more companies or subsidiaries of a company. In some instances, the prediction modelling system matches the SEC CIK company identifier (also “ID”) to a SNS company identifier based on a stock ticker symbol, a company name, or another identifying attribute of the company. The prediction modelling system may identify the parent company ID on the SNS that is associated with the matched company. This may allow for the identifying of the annual revenues of U.S. publicly traded companies at the enterprise level.

In some example embodiments, the list of the U.S. publicly traded companies may be augmented to include foreign companies, non-publicly traded U.S. companies, or both. This combined list may comprise the population of the first training data set. At this point, the annual revenue of companies outside of the population of the first training data set, including other non-US public companies as well as subsidiaries of companies, may be unknown.

The first training data set may include a number of data features obtained from SNS-maintained data, data parsed from the HTML code of one or more companies' websites, or both. The data parsed from a company's website HTML code may provide additional information regarding the amount of marketing investment the company has made in internet-related technologies and skills, and the company's level of online sophistication.

Example data features include: a company ID of the parent company; a company name of the parent company, the US stock ticker symbol for the enterprise; the sales revenue reported by the company in the past four quarters; the sales revenue from the past four quarters, divided by the number of employee members at the company; one or more verticals from groupings of company industries, with pivoted data features; one or more company industries, with pivoted data features; the age of the company in years, or an imputed value; the number of employee members from the company, excluding retirees; the number of employee members by highest educational degree attained, with pivoted data features: Doctorate degree, Master's degree, Bachelor's degree, Associate degree, High School degree, other (e.g., vocational training), none; the number of employee members by current job seniority, with pivoted data features: Owner, Partner, CXO, Vice-President, Director, Manager, Senior individual contributor, Entry level, Unpaid/Volunteer; the number of employee members by job functions, with pivoted data features; the size of company website HTML page in bytes; the number of script tags in website HTML page; the number of function tags in website HTML page; the number of class tags in website HTML page; the number of form tags in website HTML page; the number of input tags in website HTML page; the number of mailto tags in HTML page; the number of img tags in HTML page; the number of div tags in HTML page; the number of table tags in HTML page; the number of iframe tags in HTML page; the number of comments tags in HTML page; the number of object tags in HTML page; the number of flash tags in HTML page; the number of java object tags in HTML page; the number of param tags in HTML page; the number of embed tags in HTML page; the number of video embed tags in HTML page; the number of video embed tags in HTML page; flag value(s) indicating whether HTML page uses Javascript, CSS, stylesheet, favicon, jQuery, Google APIs, FastFonts, Typekit, Cloudfront, Brightcove, Bcove, Wistia, AWS, or Scene7; flag value(s) indicating whether HTML page references Pinterest, Facebook, Google+, LinkedIn, Twitter, YouTube, Slideshare, Instagram or Baidu, flag value(s) indicating whether HTML page uses Facebook Connect, Facebook App, InShare, ShareThis, AddThis, StumbleUpon, Digg, Delicious, Disqus, Doubleclick, YieldManager, Retargeter, ATDMT, AdRoll, Google Ad Services, Evidon, RichRelevance, AdReady, Chango, Criteo, Bizo, BlueKai, TheBrightTag, AdTechUs, 2o7, Mediaplex, Mercent, Advertisingcom, ValueClickMedia, Ru4, Brsrvr, HLserve, Omtrdc, BRCDN, Google Analytics, Omniture, WebTrends, Coremetrics, Optimizely, GetClicky, Quantcast, Comscore, Nielsen, Google Maps, WordPress, Drupal, CQ, or RSS; flag value(s) indicating whether HTML page references Privacy or Cart; flag value(s) indicating whether HTML page uses TrustE, LeadFormix, Hubspot, Demandbase, Marketo, Eloqua, Bloomreach, Ensighten, GrocerylQ, EverestJS, IC Live, Google Authorship, Google Site Verification, Microsoft Validate, Facebook tags, Opengraph tags, Opengraph Title tags, Twitter Card tags, Viewport tags, Apple Touch Icon tags, Apple Mobile Web tags, Apple Touch Startup tags, Form tags, Mailto tags, Tel tags, SMS tags, HTML5 version, HTML4 version, HTML3 version, HTML2 version, XHTML1 version, XHTML RDF A version, Redirect tags, Modernizr tags, or Geolocation tags; a flag value indicating whether HTML page lists a telephone number; the total combined estimated salary of employee members; the average estimated salary of each employee member; the number of employee members in each key metropolitan region; the number of employee members in each key country; whether the company is public, private, government, nonprofit, or other; the length of the company description on LinkedIn in bytes; the length of the company description on LinkedIn in bytes; whether the company uses Showcase pages on LinkedIn; the number of Showcase pages on LinkedIn associated with the company; the number of employee members who are sales professionals; the proportion of employee members who use LinkedIn primarily via Microsoft Internet Explorer web browser; the proportion of employee members who use LinkedIn primarily via Google Chrome web browser; the proportion of employee members who use LinkedIn primarily via Firefox web browser; the proportion of employee members who use LinkedIn primarily via Safari web browser; the proportion of employee members who use LinkedIn primarily via Windows OS computers; the proportion of employee members who use LinkedIn primarily via Macintosh OS computers; the proportion of employee members who use LinkedIn primarily via Linux OS computers; the number of marketing function jobs posted on LinkedIn by the company; the number of marketing industry jobs posted on LinkedIn by the company; the number of sponsored jobs posted on LinkedIn by the company; the number of jobs posted on LinkedIn by the company; the number of followers of the company on LinkedIn; the number of related subsidiary companies on LinkedIn; the number of connections by employee members to LinkedIn employee members; an indicator that the company is in the educational industry and references online or distance learning services; an indicator that the company is in the educational industry and references business classes such as for MBA programs; an identifier of the specific country with which the company is primarily associated; an identifier of the specific continent with which the company is primarily associated; an identifier of the specific sub-continent region with which the company is primarily associated; whether the company is headquartered in an English-speaking country; and whether the company is headquartered in a Eurozone country.

Some or all of these data features are included in the first training data set that is used in fitting the revenue prediction model. In some example embodiments, to increase the accuracy of the revenue prediction model, the prediction modelling system derives additional data features by taking the logarithm of certain fields, deriving a Boolean value from certain fields, or both.

In statistics and machine learning, overfitting occurs when a statistical model describes random error or noise instead of the underlying relationship. Overfitting generally occurs when a model is excessively complex, such as having too many parameters relative to the number of observations. A model that has been overfit generally has poor predictive performance, as it can exaggerate minor fluctuations in the data. In some example embodiments, a Random Forest regression algorithm is selected to fit the revenue prediction model because this algorithm does not overfit the data while still providing a good balance of accuracy and runtime performance. In order to further increase the accuracy of the revenue prediction model, the prediction modelling system may perform a linear regression on the Random Forest regression results. The revenue prediction model may be iteratively refined by adjusting, including, or excluding data features, by removing outlier training data, by correcting the input data (e.g., if the SEC filing data is originally mapped to the wrong company ID in the SNS), or a suitable combination thereof.

According to some example embodiments, the prediction modelling system may generate a revenue-per-employee value that represents a predicted revenue amount per employee of the company for a period of time, based on the revenue prediction model and a first set of data. The first set of data, in some instances, includes financial data associated with the company, member data associated with one or more members of the SNS that are employees of the company, an indicator of a marketing sophistication level associated with the company, or one or more data features described above with respect to the first training data set, or a suitable combination thereof. The prediction modelling system may then estimate the total annual revenue for the entities associated with the company (e.g., the enterprise, the parent company, child company, subsidiary, etc.) without double-counting the annual revenue at each level because each employee member is generally associated with only one such entity. In some example embodiments, each entity associated with the company is assigned a score based on the entity's annual revenue value.

### Online Advertising Spend Prediction

According to certain example embodiments, the prediction modelling system predicts the annual online advertising spend of a company, with proper estimates allocated to subsidiary companies without double-counting the annual online advertising spend at each subsidiary company level, based on an advertising spend prediction model. The advertising spend prediction model may be utilized to predict, for one or more companies, the advertising-per-employee value that represents a predicted online advertising spending amount per employee of the company in the period of time.

In some example embodiments, the prediction modelling system first trains the advertising spend prediction model based on a second training data set. The second training data set, in some instances, may be generated based on third party research data (e.g., from comScore) on internet display ad spend by one or more tracked company in the U.S. and Canada for a period of time (e.g., the last twelve months).

In some instances, the prediction modelling system matches a company ID (e.g., the name of a company obtained from comScore) to an SNS company ID (e.g., a company ID as maintained by LinkedIn) based on a company name or another identifying attribute of the company. The prediction modelling system may identify the parent company ID on the SNS that is associated with the matched company. This may allow for the identifying of the annual online advertising spend (also “Internet display ad spend”) of one or more U.S. or Canadian companies at the enterprise level.

In some example embodiments, the list of the one or more U.S. or Canadian companies comprises the population of the second training data set. At this point, the annual online advertising spend of companies outside of the population of the second training data set, including subsidiaries of the one or more companies, may be unknown.

The second training data set includes some or all of the data features included in the input to the revenue prediction model, the output of the revenue prediction model, and additional data features (e.g., data features obtained from SNS-maintained data). For example, the marketers employed by one or more companies may describe their marketing skills in their member profiles maintained by the SNS. The marketing skills associated with the marketers of a company may provide insight into the level of investment the company has made in online or digital marketing. The prediction modelling system, in some instances, utilizes an algorithm to classify marketers based on their LinkedIn profile based on multigram model, and fitted via a crowdsourced training data set. The prediction modelling system may parse the marketing skills data and may select additional data features to be included in the second training data set.

Other example data features include: the online advertising spend of a company in the most recently available twelve month period, obtained from third party (e.g., comScore) research data; the online advertising spend of the company in the most recently available prior twelve month period; the change in the online advertising spend of the company from the prior twelve month period to the most recently available twelve month period; the number of employee members of the company who are marketers; the number of employee members who are marketers with specific digital marketing skills; the average number of digital marketing skills per employee member marketer; the average number of skills per employee member marketer; the ratio of digital marketers to all marketers at the company; the average number of digital marketing skills per marketer at the company; the average number of digital marketing skills per digital marketer at the company; the ratio of digital marketing skills to all skills among marketers at the company; the number of employee members who are marketers with specific email marketing skills; the average number of email marketing skills per employee member marketer; the ratio of email marketers to all marketers at the company; the average number of email marketing skills per marketer at this company; the average number of email marketing skills per email marketer at the company; the ratio of email marketing skills to all skills among marketers at the company; the proportion of marketers at the company listing a Twitter handle on their LinkedIn profile; the proportion of marketers at the company who view LinkedIn groups; whether the company has a logo image for their company page on LinkedIn; whether the company has a “hero” banner image for their company page on LinkedIn; whether the company has listed specialty keyword tags on their company page on LinkedIn; and whether the company has a Founded Year listed on their company page on LinkedIn.

Some or all of these data features are included in the second training data set that is used in fitting the advertising spend prediction model. In some example embodiments, to increase the accuracy of the advertising spend prediction model, the prediction modelling system derives additional data features by taking the logarithm of certain fields, deriving a Boolean value from certain fields, or both.

In some example embodiments, a Random Forest regression algorithm is selected to fit the advertising spend prediction model because this algorithm does not overfit the data while still providing a good balance of accuracy and runtime performance. In order to further increase the accuracy of the advertising spend prediction model, the prediction modelling system may perform a linear regression on the Random Forest regression results. The advertising spend prediction model may be iteratively refined by adjusting, including, or excluding data features, by removing outlier training data, by correcting the input data (e.g., if the comScore data is originally mapped to the wrong company ID in the SNS), or a suitable combination thereof.

According to some example embodiments, the prediction modelling system may generate an advertising-per-employee value that represents a predicted online advertising spending amount per employee of the company in the period of time, based on the advertising spend prediction model and a second set of data. The second set of data, in some instances, includes a value indicating a digital marketing skill level associated with the members that are marketing employees of the company, member activity and behavior data associated with the one or more members, maintained by the social networking service, or one or more data features described above with respect to the second training data set, or a suitable combination thereof. The prediction modelling system may then estimate the total annual advertising spend value for the entities associated with the company (e.g., the enterprise, the parent company, child company, subsidiary, etc.) without double-counting the ad spend at each level because each employee member is generally associated with only one such entity. In some example embodiments, each entity associated with the company is assigned a score based on the entity's annual advertising spend value.

### Prediction of Share of Online Advertising Spend to be Spent on Marketing Products or Services Offered by the SNS

According to certain example embodiments, the prediction modelling system predicts, for one or more companies (or entities) on the SNS, the annual dollar amount of sales opportunities deals closed by the SNS (e.g., LinkedIn) Marketing Solutions business unit, based on a share prediction model. The share prediction model may be utilized to predict, for one or more companies, the sales-per-employee value that represents a predicted share of the advertising-per-employee value to be spent by the company on a marketing product or service provided by the SNS in a particular period of time. The sales-per-employee value may be predicted even for companies with which the SNS Marketing Solutions business unit does not have sales experiences.

In some example embodiments, the prediction modelling system first trains the share prediction model based on a third training data set. The third training data set, in some instances, may be generated based on sales opportunity win/loss records from a Customer Relationship Management (CRM) system associated with the SNS for each account associated with the one or more companies, for a period of time (e.g., the last twelve months).

In some instances, the prediction modelling system matches a CRM account ID (e.g., an account name) to an SNS company ID (e.g., a company ID as maintained by LinkedIn) based on a company name or another identifying attribute of the company. The prediction modelling system may identify the parent company ID on the SNS that is associated with the matched company. This may allow for the identifying of the sales opportunity win/loss history at the enterprise level for companies to which the representatives from the SNS Marketing Solutions business unit attempted to sell in the past.

The second training data set includes some or all of the data features included in the input to the revenue prediction model, the input to the advertising spend prediction model, the output of the revenue prediction model, the output of the advertising spend prediction model, and additional data features (e.g., data features obtained from SNS-maintained data or CRM data). For example, prediction modelling system examines the win/loss sales opportunity history for one or more companies. For a company for which the SNS stores less than a year's worth of sales history, the prediction modelling system extrapolates the latest sales opportunity win/loss status to the full year. For a company where the latest sales opportunity resulted in a lost opportunity, the prediction modelling system identifies the twelve-month sales amount won as the maximum expected spend from the company. For a company where the latest sales opportunity resulted in a won opportunity, the prediction modelling system multiplies the twelve-month sales amount won by a growth factor value to determine the maximum expected spend from the company.

Other example data features include: whether the company description refers to products and services prohibited by LinkedIn advertising guidelines such as adult services, drugs, and explosives; how much the company has spent on LinkedIn Ads in the past twelve months; how much the company has spent on LinkedIn Sponsored Updates in the past twelve months; the number of recorded sales opportunities associated with the company for LinkedIn Talent Solutions won in the past twelve months; the number of recorded sales opportunities associated with the company for LinkedIn Marketing Solutions won in the past twelve months; the number of recorded sales opportunities associated with the company for LinkedIn Sales Solutions won in the past twelve months; the number of recorded sales opportunities associated with the company for LinkedIn Talent Solutions lost in the past twelve months; the number of recorded sales opportunities associated with the company for LinkedIn Marketing Solutions lost in the past twelve months; the number of recorded sales opportunities associated with the company for LinkedIn Sales Solutions lost in the past twelve months; the dollar amount of sales opportunities won by LinkedIn Talent Solutions from the company in the past twelve months; the dollar amount of sales opportunities won by LinkedIn Marketing Solutions from the company in the past twelve months; the dollar amount of sales opportunities won by LinkedIn Sales Solutions from the company in the past twelve months; the number of company status updates posted by the company on LinkedIn in the past twelve months; the number of targeted company status updates posted by the company on LinkedIn in the past twelve months; the total number of impressions generated by company status updates posted by the company on LinkedIn in the past twelve months; the total number of clicks generated by company status updates posted by the company on LinkedIn in the past twelve months; the total number of likes generated by company status updates posted by the company on LinkedIn in the past twelve months; the total number of comments generated by company status updates posted by the company on LinkedIn in the past twelve months; the total number of shares generated by company status updates posted by the company on LinkedIn in the past twelve months; and the number of company status updates posted by the company on LinkedIn via an API partner in the past twelve months.

Some or all of these data features are included in the third training data set that is used in fitting the share prediction model. In some example embodiments, to increase the accuracy of the advertising spend prediction model, the prediction modelling system derives additional data features by taking the logarithm of certain fields, deriving a Boolean value from certain fields, or both.

In some example embodiments, a Random Forest regression algorithm is selected to fit the share prediction model because this algorithm does not overfit the data while still providing a good balance of accuracy and runtime performance. In order to further increase the accuracy of the advertising spend prediction model, the prediction modelling system may perform a linear regression on the Random Forest regression results. The share prediction model may be iteratively refined by adjusting, including, or excluding data features, by removing outlier training data, by correcting the input data (e.g., if the CRM account data is originally mapped to the wrong company ID in the SNS), or a suitable combination thereof.

According to some example embodiments, the prediction modelling system may generate a sales-per-employee value that represents a predicted share of the advertising-per-employee value to be spent by the company on a marketing product or service provided by the social networking service in the period of time, based on the share prediction model and a third set of data. The third set of data, in some instances, includes sales data associated with one or more companies (e.g., sales opportunity win or loss records associated with the one or more companies from a CRM system associated with the SNS, for a period of time) or one or more data features described above with respect to the third training data set, or a suitable combination thereof. The prediction modelling system may then estimate, for each of the entities associated with the company (e.g., the enterprise, the parent company, child company, subsidiary, etc.), the maximum amount of the digital advertising spend of the company to be spent by the entity on a marketing product or service provided by the SNS, in the period of time, without double-counting the ad spend at each level because each employee member is generally associated with only one such entity. In some example embodiments, each entity associated with the company is assigned a score based on the share (or dollar amount) of the annual digital advertising spend value expected to be spent by the entity on digital advertising products or services offered by the SNS, in the period of time. The prediction modelling system, in some instances, prioritized identifiers of customer companies or prospects for contacting by sales people, based on the share of the annual digital advertising spend value expected to be spent by the customer companies or prospects on digital advertising products or services offered by the SNS during a period of time.

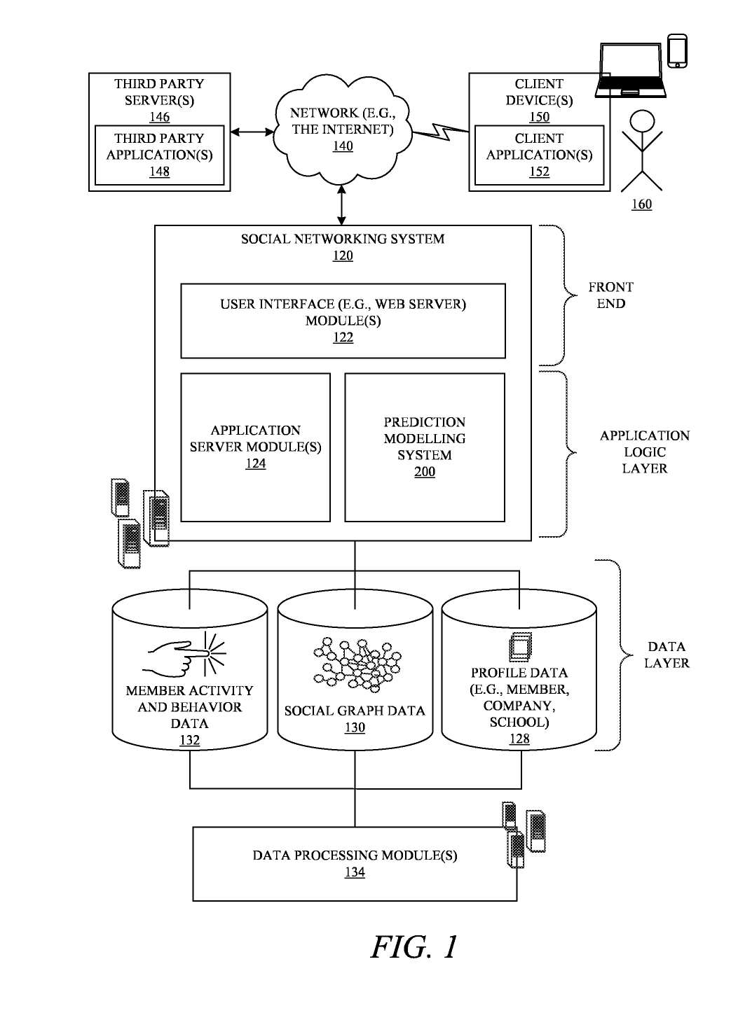

An example method and system for determining a predicted share of an online advertising budget to be spent by a company on a marketing product or service provided by a social networking service, in a period of time, may be implemented in the context of the client-server system illustrated in FIG. 1. As illustrated in FIG. 1, the prediction modelling system 200 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social networking service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130.

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include the prediction modelling system 200, which is described in more detail below.

Further, as shown in FIG. 1, a data processing module 134 may be used with a variety of applications, services, and features of the social networking system 120. The data processing module 134 may periodically access one or more of the databases 128, 130, or 132, process (e.g., execute batch process jobs to analyze or mine) profile data, social graph data, or member activity and behavior data, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers, such as Hadoop servers for processing large data sets. The data processing module 134 may process data in real time, according to a schedule, automatically, or on demand.

In some example embodiments, the data processing modules 134 may perform an analysis of profile data associated with a plurality of actual or potential customers (e.g., companies) of the social networking service. For example, the data processing module 134 analyzes the company profile data and financial data pertaining to the plurality of companies, various types of member data associated with a number of employee members of the plurality of companies and maintained by the social networking service, data pertaining to the internet display ad spend by one or more companies, or sales opportunity win/loss records associated with one or more companies, and facilitate a revenue prediction modeling process, an advertising spend prediction modeling process, or a share prediction modeling process performed by the prediction modelling system 200. The results of the analyses performed by the data processing module 134 may be stored for further use, in one or more of the databases 128, 130, or 132, or in another database.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

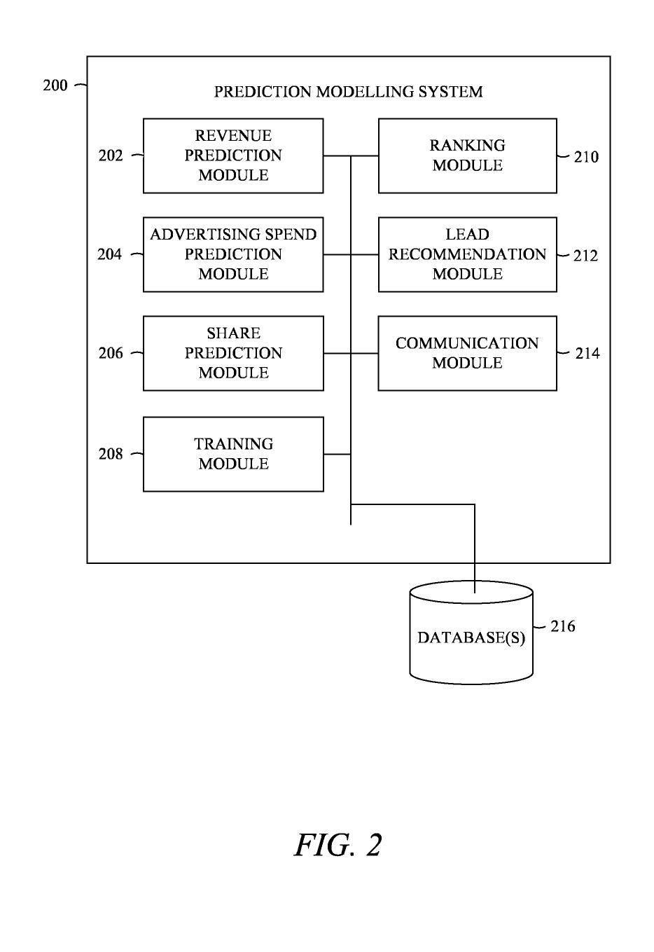

FIG. 2 is a block diagram illustrating components of the prediction modelling system 200, according to some example embodiments. As shown in FIG. 2, the prediction modelling system 200 includes a revenue prediction module 202, an advertising spend prediction module 204, a share prediction module 206, a training module 208, a ranking module 210, a lead recommendation module 212, and a communication module 214, all configured to communicate with each other (e.g., via a bus, shared memory, or a switch).

According to some example embodiments, the revenue prediction module 202 accesses a first set of data to be used for performing a revenue prediction modeling process. The first set of data includes financial data associated with a company, member data associated with one or more members of a social networking service that are employees of the company, and an indicator of a marketing sophistication level associated with the company. The revenue prediction module 202 performs a revenue prediction modeling process based on the first set of data and a revenue prediction model. The performing of the revenue prediction modeling process generates a revenue-per-employee value that represents a predicted revenue amount per employee of the company for a period of time.

The advertising spend prediction module 204 accesses a second set of data to be used for performing an advertising spend prediction modeling process. The second set of data includes a value indicating a digital marketing skill level associated with the members that are marketing employees of the company, and member activity and behavior data associated with the one or more members. Some or all the data in the second set of data is maintained by the social networking service. The advertising spend prediction module 204 performs an advertising spend prediction modeling process based on the revenue-per-employee value, the second set of data, and an advertising spend prediction model. The performing of the advertising spend prediction modeling process generates an advertising-per-employee value that represents a predicted online advertising spending amount per employee of the company in the period of time.

The share prediction module 206 accesses sales data associated with the company. The sales data, in some instances, is maintained by the social networking service. The share prediction module 206 performs a share prediction modeling process based on the advertising-per-employee value, the sales data, and a share prediction model. The performing of the share prediction modeling process generates a sales-per-employee value that represents a predicted share of the advertising-per-employee value to be spent by the company on a marketing product or service provided by the social networking service, in the period of time.

The training module 208 performs training operations to train the models of the prediction modelling system 200. According to some example embodiments, the training module 208 performs a first training operation to train the revenue prediction model based on a first training data set. The training module 208 performs a second training operation to train the advertising spend prediction model. The training module 208 performs a third training operation to train the share prediction model based on a third training data set.

The ranking module 210 ranks a plurality of company identifiers that each identifies one of a plurality of companies, based on a plurality of predicted sales values corresponding to the amounts to be spent by the plurality of companies on marketing products or services provided by the SNS over a period of time. The lead recommendation module 212 determines that one or more predicted sales values corresponding to one or more companies exceed a threshold value, and generates a lead recommendation that indicates that the one or more companies are associated with predicted sales values that exceed the threshold value.

The communication module 214 communicates information related to the functionalities of the prediction modelling system to a device of a user (e.g., a salesperson, a marketer, an administrator, etc.). According to some example embodiments, the communication module 214 causes presentation of the revenue-per-employee value in a user interface of the device. In some example embodiments, the communication module 214 causes presentation of the revenue value for the company and a reference to the company in the user interface of the device. The communication module 214, in certain example embodiments, causes presentation of the advertising spend value for the company and a reference to the company in the user interface of the device. The communication module 214, in certain example embodiments, causes presentation of the sales-per-employee value associated with the company and a reference to the company in the user interface of the device. Consistent with some example embodiments, the communication module 214 causes presentation of the ranked plurality of company identifiers and the plurality of predicted sales values corresponding to the plurality of companies in the user interface of the device. In various example embodiments, the communication module 214 causes presentation of the lead recommendation in the user interface of the device.

To perform one or more of its functionalities, the prediction modelling system 200 may communicate with one or more other systems. An integration engine may integrate the prediction modelling system 200 with one or more email server(s), web server(s), a central asset repository, or other servers or systems. A measurement and reporting engine may determine the performance of one or more modules of the prediction modelling system 200. An optimization engine may optimize one or more of the models associated with one or more modules of the prediction modelling system 200.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 216 (e.g., the database 128, the database 130, the database 132, etc.).

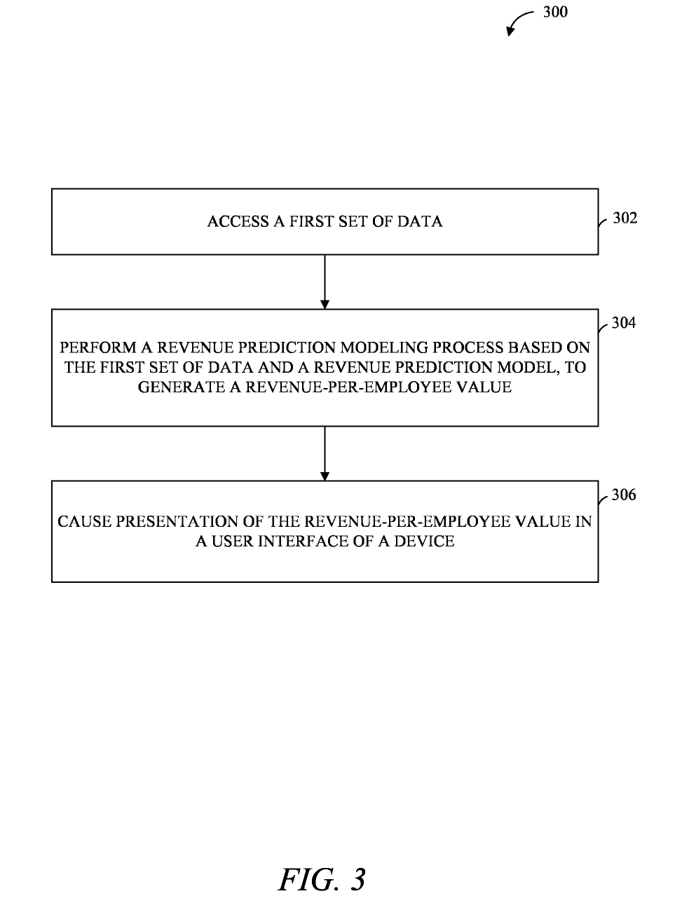

FIGS. 3-13 are flowcharts illustrating a method of determining a predicted share of an online advertising budget to be spent by a company on a marketing product or service provided by a social networking service, in a period of time, according to some example embodiments. Operations in the method 300 illustrated in FIG. 3 may be performed using modules described above with respect to FIG. 2. As shown in FIG. 3, the method 300 may include one or more of method operations 302, 304, and 306, according to some example embodiments.

At method operation 302, the revenue prediction module 202 accesses a first set of data. The first set of data may include financial data associated with a company, member data associated with one or more members of a social networking service that are employees of the company, and an indicator of a marketing sophistication level associated with the company. The financial data includes at least one of publicly available financial information pertaining to the company, and proprietary information pertaining to one or more transactions between the company and the social networking service. The member data includes at least one of a name of a member of the social networking service, a gender, an age, a current job title, a previous job title, a name of a current employer, a name of a previous employer, a location, an industry, an identifier of an education institution, an identifier of employment experience, a skill, an identifier of a group, and an identifier of a member connection.

At method operation 304, the revenue prediction module 202 performs a revenue prediction modeling process based on the first set of data and a revenue prediction model, to generate a revenue-per-employee value. The revenue-per-employee value represents a predicted revenue amount per employee of the company for a period of time. At method operation 306, the communication module 214 causes presentation of the revenue-per-employee value in a user interface of the device.

According to some example embodiments, the method 300 includes one or more additional operations. In some instances, the training module 208 performs a first training operation to train the revenue prediction model based on a first training data set. The first training data set includes at least one of financial filings data for one or more publicly traded companies, annual revenue data for one or more foreign companies, annual revenue data for one or more non-publicly traded companies, and a percentage of employees per type of employee that are employed by the one or more publicly traded companies, the one or more foreign companies, or the one or more non-publicly traded companies.

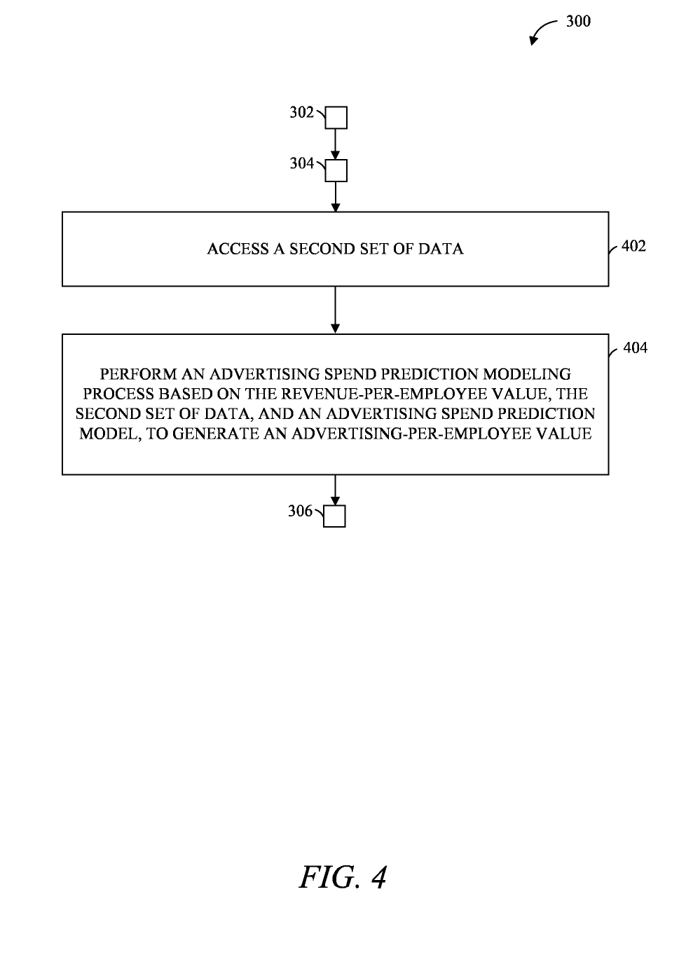

In some example embodiments, the method 300 further comprises computing (e.g., by the revenue prediction module 202) a revenue value for the company based on the revenue-per-employee value and a number of employees of the company. The revenue value represents a predicted revenue amount for the company for the period of time. The method 300 further comprises causing (e.g., the communication module 214) presentation of the revenue value for the company and a reference to the company in the user interface of the device. Further details with respect to the method operations of the method 300 are described below with respect to FIGS. 4-13.

As shown in FIG. 4, the method 300 may include one or more of method operations 402 and 404, according to some example embodiments. Method operation 402 is performed after method operation 304, in which the revenue prediction module 202 performs a revenue prediction modeling process based on the first set of data and a revenue prediction model, to generate a revenue-per-employee value that represents a predicted revenue amount per employee of the company for a period of time.

At method operation 402, the advertising spend prediction module 204 accesses a second set of data. The second set of data may include a value indicating a digital marketing skill level associated with the members that are marketing employees of the company, and member activity and behavior data associated with the one or more members. The data included in the second set of data may be maintained by the social networking service.

Method operation 404 is performed after method operation 402. At method operation 404, the advertising spend prediction module 204 performs an advertising spend prediction modeling process based on the revenue-per-employee value, the second set of data, and an advertising spend prediction model, to generate an advertising-per-employee value. The advertising-per-employee value that represents a predicted online advertising spending amount per employee of the company in the period of time. In some instances, the communication module 214 causes presentation of the advertising-per-employee value associated with the company, in the user interface of the device.

According to some example embodiments, the method 300 includes one or more additional operations. In some instances, the training module 208 performs a second training operation to train the advertising spend prediction model. The second training data set includes at least one of research data pertaining to online advertising amounts spent by one or more companies during a particular period of time, and social networking engagement data that identifies levels of engagement with the social networking service by the one or more companies.

In some example embodiments, the method 300 further comprises computing an advertising spend value for the company based on the advertising-per-employee value and a number of employees of the company. The advertising spend value represents a predicted online advertising amount to be spent by the company in the period of time. The method 300 further comprises causing presentation of the advertising spend value for the company and a reference to the company in the user interface of the device.

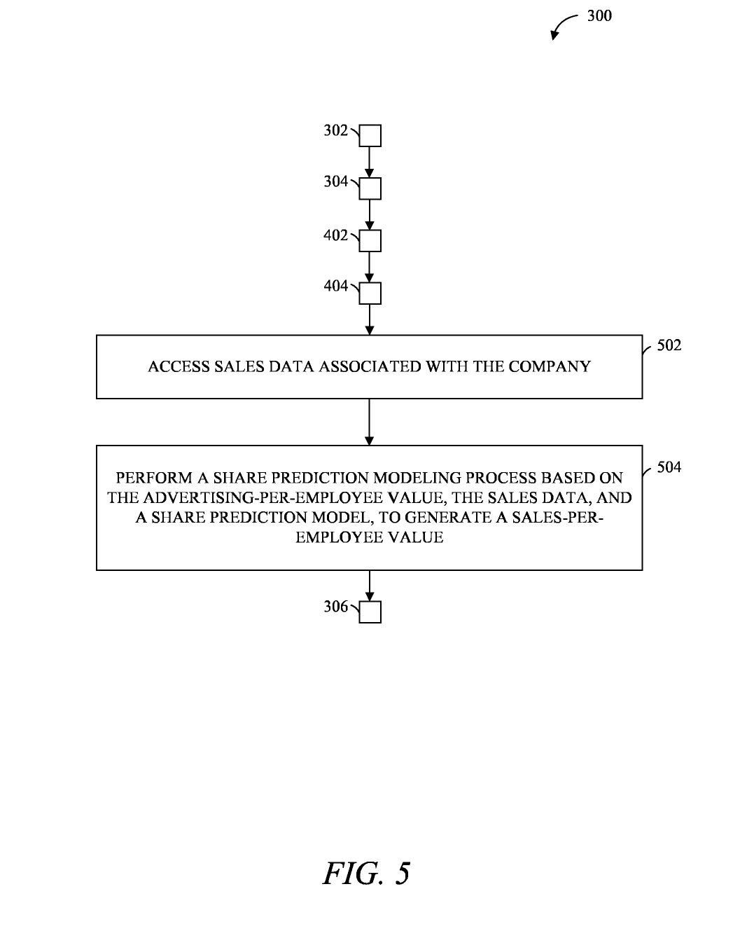

As shown in FIG. 5, the method 300 may include one or more of method operations 502 and 504, according to some example embodiments. Method operation 502 is performed after method operation 404, in which the advertising spend prediction module 204 performs the advertising spend prediction modeling process. At method operation 502, the share prediction module 206 accesses sales data associated with the company. The sales data may be maintained by the social networking service.

At method operation 504, the share prediction module 206 performs a share prediction modeling process based on the advertising-per-employee value, the sales data, and a share prediction model, to generate a sales-per-employee value for the company. The sales-per-employee value represents a predicted share of the advertising-per-employee value to be spent by the company on a marketing product or service provided by the social networking service, in the period of time. In some instances, the communication module 214 causes presentation of the sales-per-employee value associated with the company, in the user interface of the device.

According to some example embodiments, the method 300 includes one or more additional operations. In some instances, the training module 208 performs a third training operation to train the share prediction model based on a third training data set. The third training data set includes sales opportunity history data for one or more companies identified as accounts in a Customer Relationship Management (CRM) system associated with the social networking service.

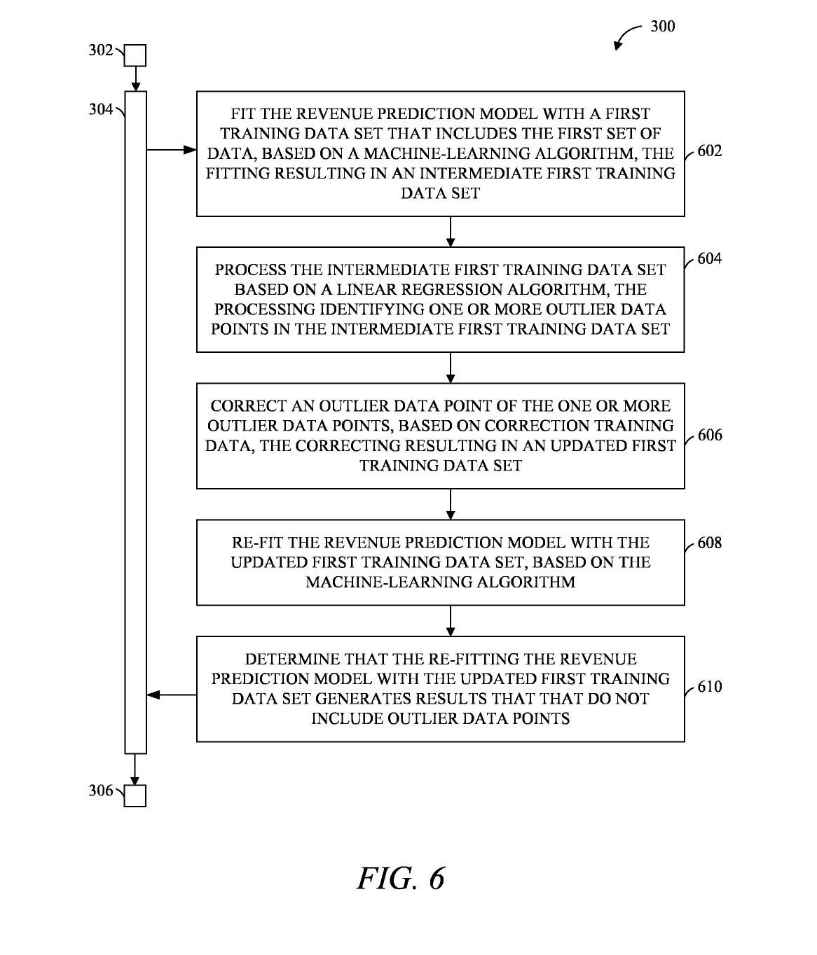

As shown in FIG. 6, the method 300 may include one or more of operations 602, 604, 606, 608, and 610, according to some example embodiments. Method operation 602 may be performed as part (e.g., a precursor task, a subroutine, or a portion) of method operation 304, in which the revenue prediction module 202 performs a revenue prediction modeling process based on the first set of data and a revenue prediction model, to generate a revenue-per-employee value that represents a predicted revenue amount per employee of the company for a period of time. At method operation 602, the revenue prediction module 202 fits the revenue prediction model with a first training data set that includes the first set of data, based on a machine-learning algorithm, the fitting resulting in an intermediate first training data set.

Method operation 604. At method operation 604, the revenue prediction module 202 processes the intermediate first training data set based on a linear regression algorithm. The processing identifies one or more outlier data points in the intermediate first training data set. In statistics, an outlier data point is an observation point that is distant from other observations. An outlier may be due to variability in the measurement or it may indicate experimental error. In some instances, the outlier data points are excluded from the data set.

Method operation 606. At method operation 606, the revenue prediction module 202 corrects an outlier data point of the one or more outlier data points, based on correction training data. The correction training data may indicate one or more rules for correcting the one or more outlier data points. The correcting may result in an updated first training data set.

Method operation 608. At method operation 608, the revenue prediction module 202 re-fits the revenue prediction model with the updated first training data set, based on the machine-learning algorithm.

Method operation 610. At method operation 610, the revenue prediction module 202 determines that the re-fitting the revenue prediction model with the updated first training data set generates results that that do not include outlier data points.

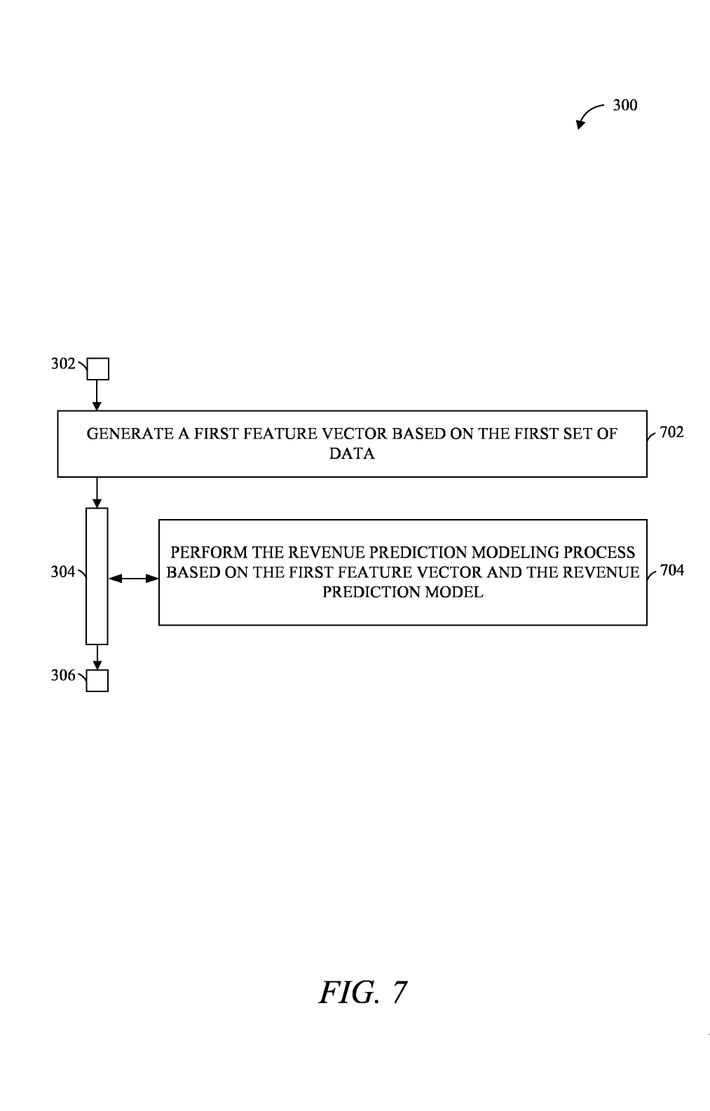

As shown in FIG. 7, the method 300 may include one or more of method operations 702 and 704, according to some example embodiments. Method operation 702 may be performed after method operation 302, in which the revenue prediction module 202 accesses a first set of data including financial data associated with a company, member data associated with one or more members of a social networking service that are employees of the company, and an indicator of a marketing sophistication level associated with the company. At method operation 702, the revenue prediction module 202 generates a first feature vector based on the first set of data. The first feature vector may include various features included in the first set of data.

Method operation 704 may be performed as part (e.g., a precursor task, a subroutine, or a portion) of method operation 304, in which the revenue prediction module 202 performs a revenue prediction modeling process based on the first set of data and a revenue prediction model, to generate a revenue-per-employee value that represents a predicted revenue amount per employee of the company for a period of time. At method operation 704, the revenue prediction module 202 performs the revenue prediction modeling process based on the first feature vector and the revenue prediction model. According to some example embodiments, the revenue prediction model has been trained based on the first training data set before the revenue prediction module 202 performs the revenue prediction modeling process based on the first feature vector and the revenue prediction model.

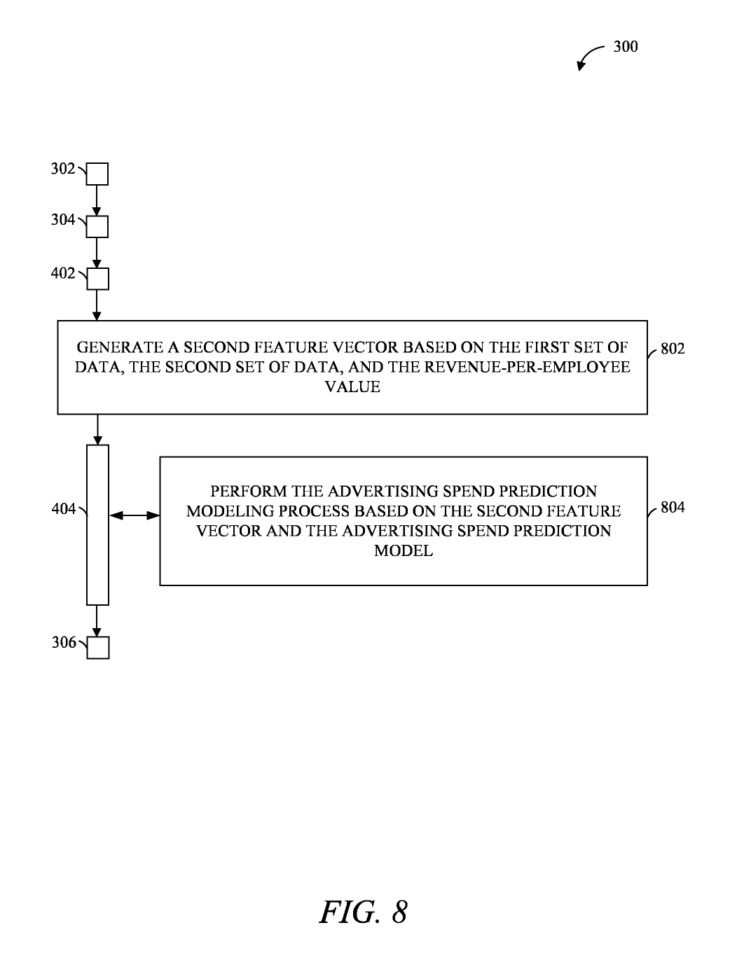

As shown in FIG. 8, the method 300 may include one or more of method operations 802 and 804, according to some example embodiments. Method operation 802 may be performed after method operation 402, in which the advertising spend prediction module 204 accesses a second set of data including a value indicating a digital marketing skill level associated with the members that are marketing employees of the company, and member activity and behavior data associated with the one or more members. At method operation 802, the advertising spend prediction module 204 generates a second feature vector based on the first set of data, the second set of data, and the revenue-per-employee value. The second feature vector may include various features included in the first set of data, the second set of data, and the revenue-per-employee value.

Method operation 804 may be performed as part (e.g., a precursor task, a subroutine, or a portion) of method operation 404, in which the advertising spend prediction module 204 performs an advertising spend prediction modeling process based on the revenue-per-employee value, the second set of data, and an advertising spend prediction model, to generate an advertising-per-employee value that represents a predicted online advertising spending amount per employee of the company in the period of time. At method operation 804, the advertising spend prediction module 204 performs the advertising spend prediction modeling process based on the second feature vector and the advertising spend prediction model. According to some example embodiments, the advertising spend prediction model has been trained based on the second training data set before the advertising spend prediction module 204 performs the advertising spend prediction modeling process based on the second feature vector and the advertising spend prediction model.

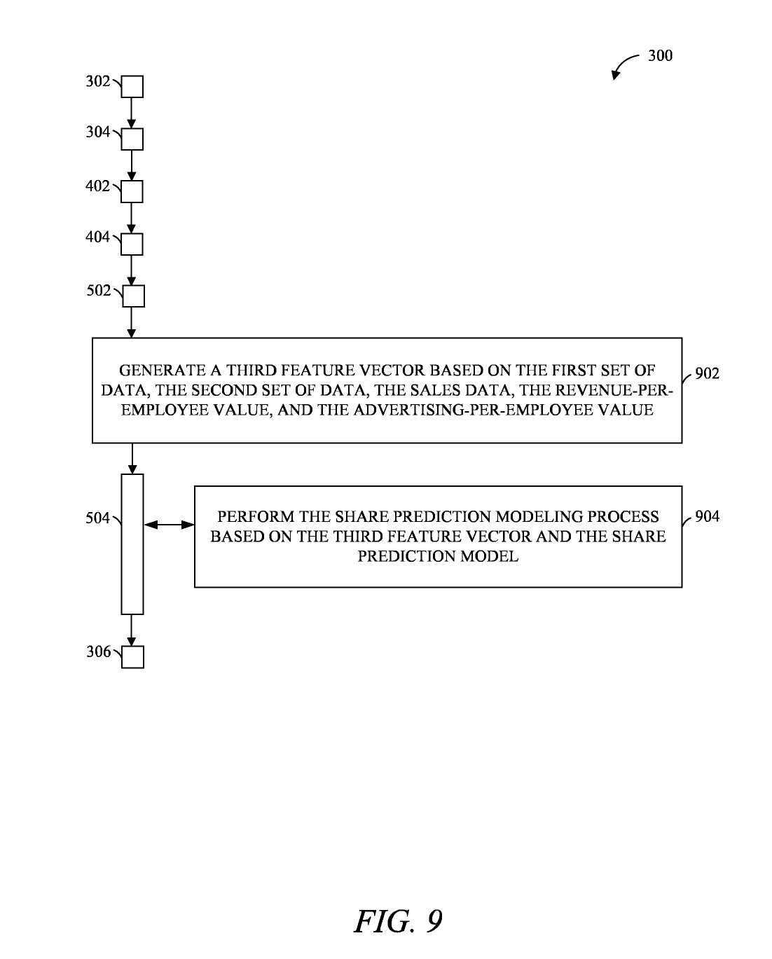

As shown in FIG. 9, the method 300 may include one or more of method operations 902 and 904, according to some example embodiments. Method operation 902 may be performed after method operation 502, in which the share prediction module 206 accesses sales data associated with the company. At method operation 902, the share prediction module 206 generates a third feature vector based on the first set of data, the second set of data, the sales data, the revenue-per-employee value, and the advertising-per-employee value. The third feature vector may include various features included in the first set of data, the second set of data, the sales data, the revenue-per-employee value, and the advertising-per-employee value.

Method operation 904 may be performed as part (e.g., a precursor task, a subroutine, or a portion) of method operation 504, in which the share prediction module 206 performs a share prediction modeling process based on the advertising-per-employee value, the sales data, and a share prediction model, to generate a sales-per-employee value for the company. At method operation 902, the share prediction module 206 performs the share prediction modeling process based on the third feature vector and the share prediction model. According to some example embodiments, the share prediction model has been trained based on the third training data set before the share prediction module 206 performs the share prediction modeling process based on the third feature vector and the share prediction model.

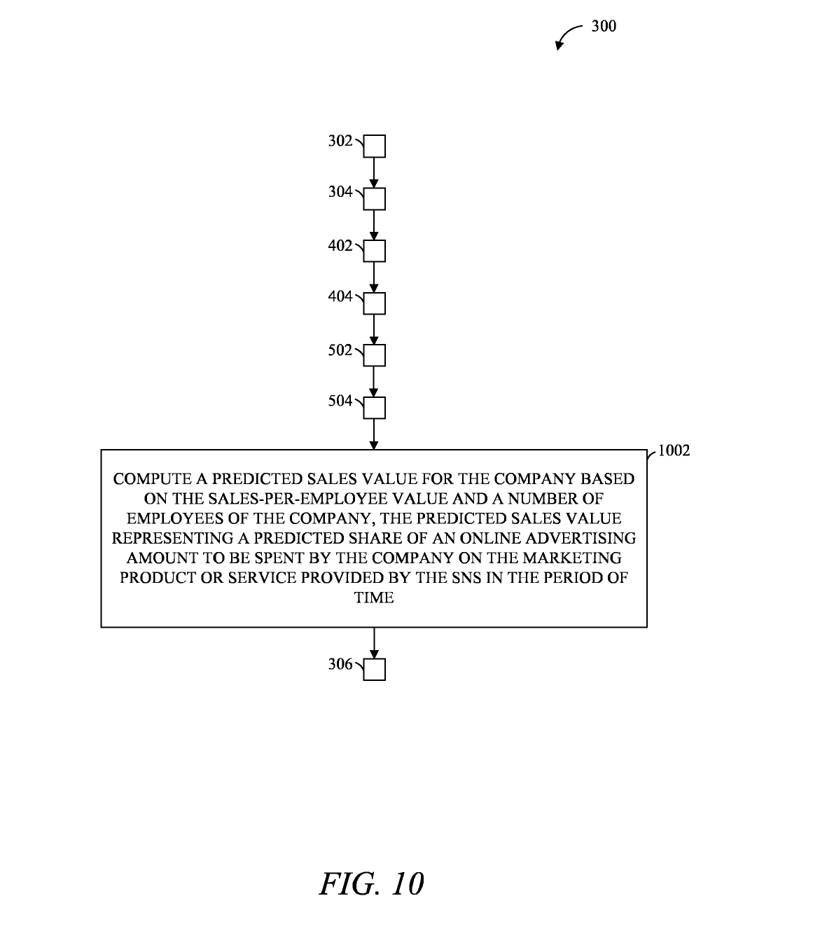

As shown in FIG. 10, the method 300 may include method operation 1002, according to some example embodiments. Method operation 1002 may be performed after method operation 504, in which the share prediction module 206 performs a share prediction modeling process based on the advertising-per-employee value, the sales data, and a share prediction model, to generate a sales-per-employee value for the company. At method operation 1002, the share prediction module 206 computes a predicted sales value for the company based on the sales-per-employee value and a number of employees of the company, the predicted sales value representing a predicted share of an online advertising amount to be spent by the company on the marketing product or service provided by the social networking service in the period of time. According to some example embodiments, the communication module 214 causes presentation of the predicted sales value for the company, in the user interface of the device.

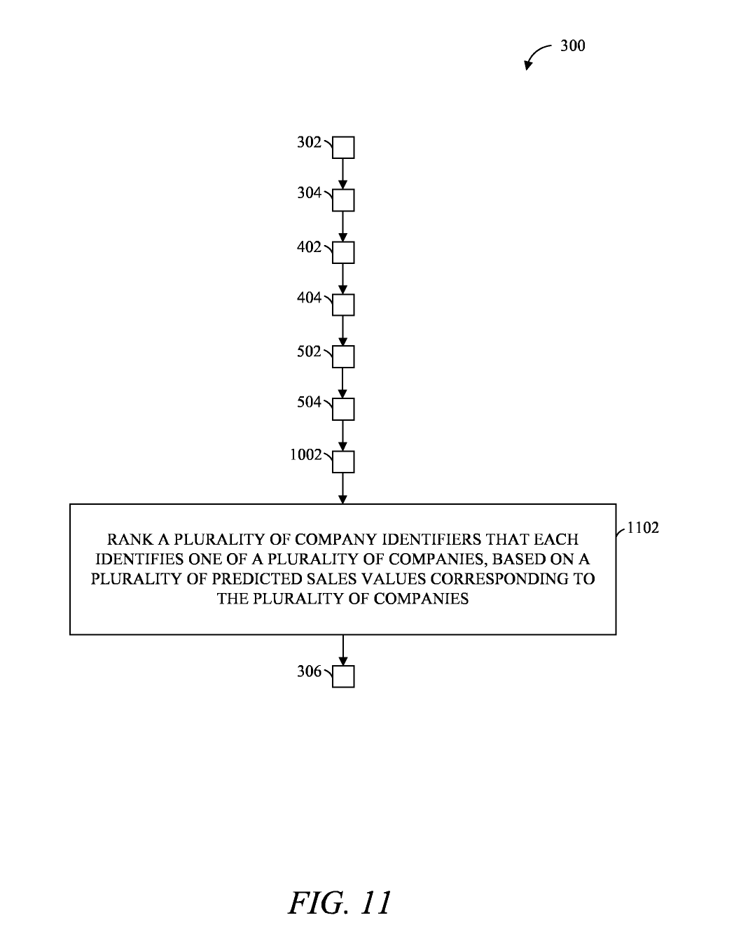

As shown in FIG. 11, the method 300 may include method operation 1102, according to some example embodiments. Method operation 1102 may be performed after method operation 1002, in which the share prediction module 206 computes a predicted sales value for the company based on the sales-per-employee value and a number of employees of the company, the predicted sales value representing a predicted share of an online advertising amount to be spent by the company on the marketing product or service provided by the social networking service in the period of time.

At method operation 1102, the ranking module 210 ranks a plurality of company identifiers that each identifies one of a plurality of companies. The ranking module 210 may rank the plurality of company identifiers based on a plurality of predicted sales values corresponding to the plurality of companies. The plurality of company identifiers include a company identifier that identifies the company, and the plurality of predicted sales values include the predicted sales value corresponding to the company.

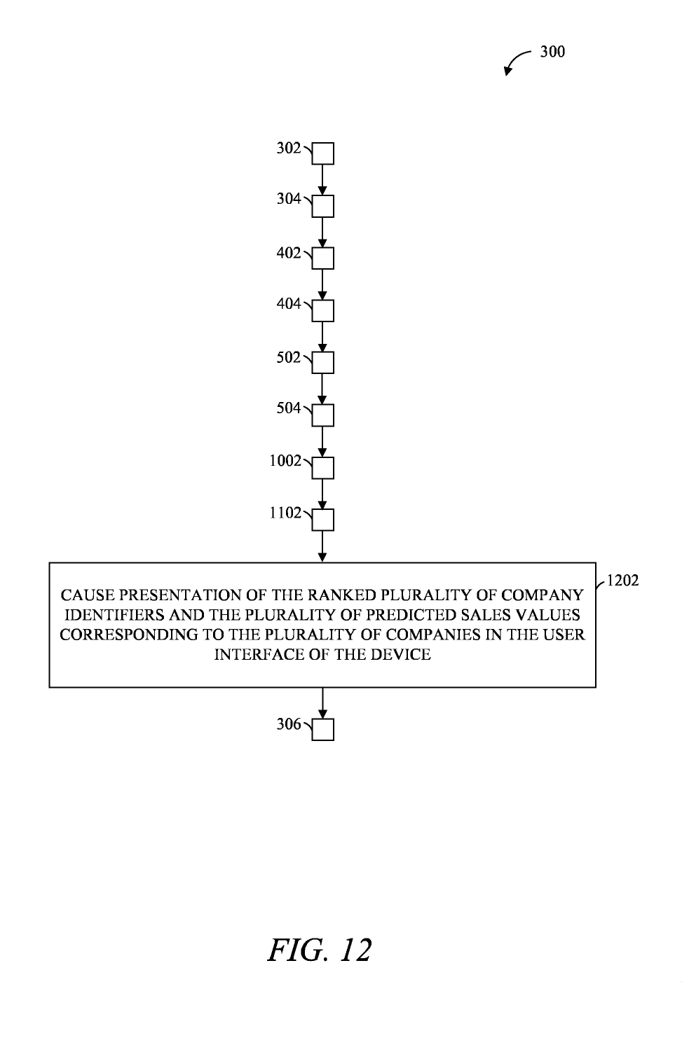

As shown in FIG. 12, the method 300 may include method operation 1202, according to some example embodiments. Method operation 1202 may be performed after method operation 1102, in which the ranking module 210 ranks a plurality of company identifiers that each identifies one of a plurality of companies. At method operation 1202, the communication module 214 causes presentation of the ranked plurality of company identifiers and the plurality of predicted sales values corresponding to the plurality of companies in the user interface of the device.

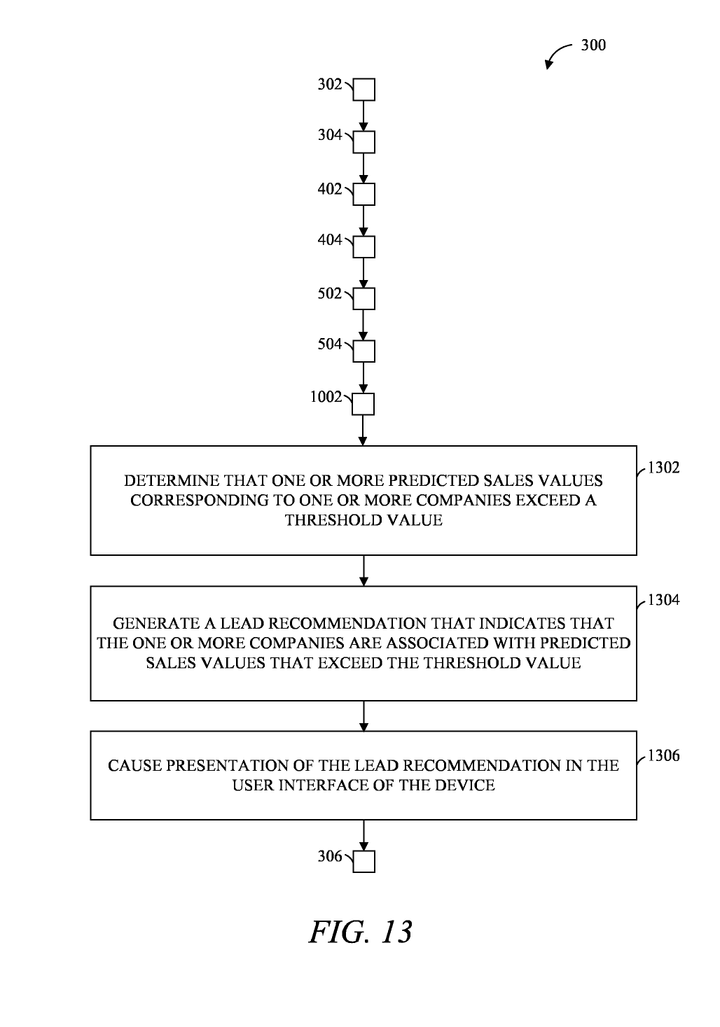

As shown in FIG. 13, the method 300 may include one or more of the method operations 1302, 1304, and 1306, according to some example embodiments. Method operation 1302 may be performed after method operation 1002, in which the share prediction module 206 computes a predicted sales value for the company based on the sales-per-employee value and a number of employees of the company, the predicted sales value representing a predicted share of an online advertising amount to be spent by the company on the marketing product or service provided by the social networking service in the period of time.

At method operation 1302, the lead recommendation module 212 determines that one or more predicted sales values corresponding to one or more companies exceed a threshold value. The one or more companies include the company.

Method operation 1304 may be performed after method operation 1302. At method operation 1304, the lead recommendation module 212 generates a lead recommendation that indicates that the one or more companies are associated with predicted sales values that exceed the threshold value.

Method operation 1306 may be performed after method operation 1304. At method operation 1306, the communication module 214 causes presentation of the lead recommendation in the user interface of the device.

### Example Mobile Device

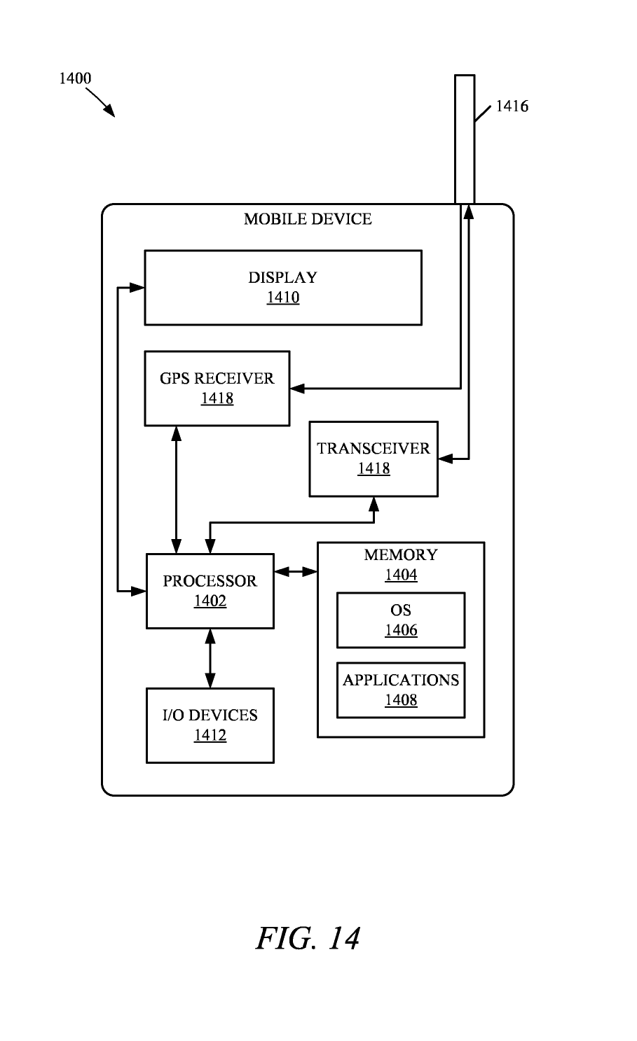

FIG. 14 is a block diagram illustrating a mobile device 1400, according to an example embodiment. The mobile device 1400 may include a processor 1402. The processor 1402 may be any of a variety of different types of commercially available processors 1402 suitable for mobile devices 1400 (for example, an XScale architecture microprocessor, a microprocessor without interlocked pipeline stages (MIPS) architecture processor, or another type of processor 1402). A memory 1404, such as a random access memory (RAM), a flash memory, or other type of memory, is typically accessible to the processor 1402. The memory 1404 may be adapted to store an operating system (OS) 1406, as well as application programs 1408, such as a mobile location enabled application that may provide LBSs to a user. The processor 1402 may be coupled, either directly or via appropriate intermediary hardware, to a display 1410 and to one or more input/output (I/O) devices 1412, such as a keypad, a touch panel sensor, a microphone, and the like. Similarly, in some embodiments, the processor 1402 may be coupled to a transceiver 1414 that interfaces with an antenna 1416. The transceiver 1414 may be configured to both transmit and receive cellular network signals, wireless data signals, or other types of signals via the antenna 1416, depending on the nature of the mobile device 1400. Further, in some configurations, a GPS receiver 1418 may also make use of the antenna 1416 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

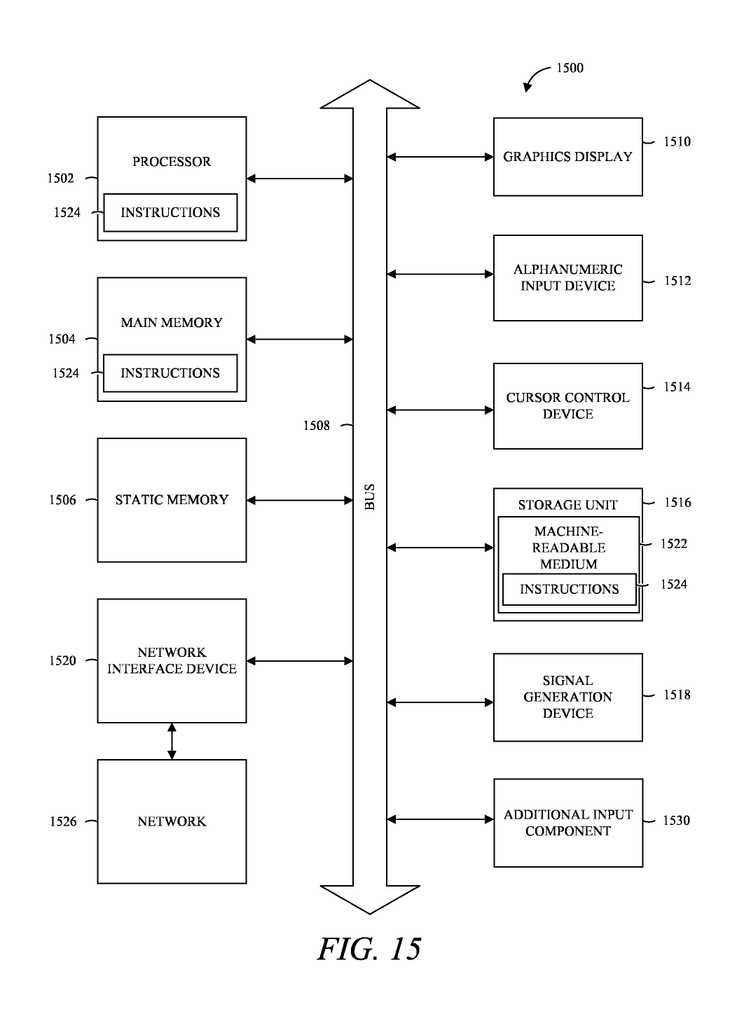

FIG. 15 is a block diagram illustrating components of a machine 1500, according to some example embodiments, able to read instructions 1524 from a machine-readable medium 1522 (e.g., a non-transitory machine-readable medium, a machine-readable storage medium, a computer-readable storage medium, or any suitable combination thereof) and perform any one or more of the methodologies discussed herein, in whole or in part. Specifically, FIG. 15 shows the machine 1500 in the example form of a computer system (e.g., a computer) within which the instructions 1524 (e.g., software, a program, an application, an applet, an app, or other executable code) for causing the machine 1500 to perform any one or more of the methodologies discussed herein may be executed, in whole or in part.

In alternative embodiments, the machine 1500 operates as a standalone device or may be connected (e.g., networked) to other machines. In a networked deployment, the machine 1500 may operate in the capacity of a server machine or a client machine in a server-client network environment, or as a peer machine in a distributed (e.g., peer-to-peer) network environment. The machine 1500 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1524, sequentially or otherwise, that specify actions to be taken by that machine. Further, while only a single machine is illustrated, the term “machine” shall also be taken to include any collection of machines that individually or jointly execute the instructions 1524 to perform all or part of any one or more of the methodologies discussed herein.

The machine 1500 includes a processor 1502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1504, and a static memory 1506, which are configured to communicate with each other via a bus 1508. The processor 1502 may contain microcircuits that are configurable, temporarily or permanently, by some or all of the instructions 1524 such that the processor 1502 is configurable to perform any one or more of the methodologies described herein, in whole or in part. For example, a set of one or more microcircuits of the processor 1502 may be configurable to execute one or more modules (e.g., software modules) described herein.

The machine 1500 may further include a graphics display 1510 (e.g., a plasma display panel (PDP), a light emitting diode (LED) display, a liquid crystal display (LCD), a projector, a cathode ray tube (CRT), or any other display capable of displaying graphics or video). The machine 1500 may also include an alphanumeric input device 1512 (e.g., a keyboard or keypad), a cursor control device 1514 (e.g., a mouse, a touchpad, a trackball, a joystick, a motion sensor, an eye tracking device, or other pointing instrument), a storage unit 1516, an audio generation device 1518 (e.g., a sound card, an amplifier, a speaker, a headphone jack, or any suitable combination thereof), and a network interface device 1520.

The storage unit 1516 includes the machine-readable medium 1522 (e.g., a tangible and non-transitory machine-readable storage medium) on which are stored the instructions 1524 embodying any one or more of the methodologies or functions described herein. The instructions 1524 may also reside, completely or at least partially, within the main memory 1504, within the processor 1502 (e.g., within the processor's cache memory), or both, before or during execution thereof by the machine 1500. Accordingly, the main memory 1504 and the processor 1502 may be considered machine-readable media (e.g., tangible and non-transitory machine-readable media). The instructions 1524 may be transmitted or received over the network 1526 via the network interface device 1520. For example, the network interface device 1520 may communicate the instructions 1524 using any one or more transfer protocols (e.g., hypertext transfer protocol (HTTP)).

In some example embodiments, the machine 1500 may be a portable computing device, such as a smart phone or tablet computer, and have one or more additional input components 1530 (e.g., sensors or gauges). Examples of such input components 1530 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1522 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1524 for execution by the machine 1500, such that the instructions 1524, when executed by one or more processors of the machine 1500 (e.g., processor 1502), cause the machine 1500 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing a first set of data including financial data associated with a company, member data associated with one or more members of a social networking service that are employees of the company, and an indicator of a marketing sophistication level associated with the company;
performing, using one or more hardware processors, a revenue prediction modeling process based on the first set of data and a revenue prediction model, to generate a revenue-per-employee value that represents a predicted revenue amount per employee of the company for a period of time; and
causing presentation of the revenue-per-employee value in a user interface of a device.

2. The method of claim 1, wherein the performing of the revenue prediction modeling process includes:
fitting the revenue prediction model with a first training data set that includes the first set of data, based on a machine-learning algorithm, the fitting resulting in an intermediate first training data set;
processing the intermediate first training data set based on a linear regression algorithm, the processing identifying one or more outlier data points in the intermediate first training data set;
correcting an outlier data point of the one or more outlier data points, based on correction training data, the correcting resulting in an updated first training data set;
re-fitting the revenue prediction model with the updated first training data set, based on the machine-learning algorithm; and
determining that the re-fitting the revenue prediction model with the updated first training data set generates results that that do not include outlier data points.

3. The method of claim 1, further comprising generating a first feature vector based on the first set of data, and
wherein the performing of the revenue prediction modeling process based on the first set of data and the revenue prediction model includes performing the revenue prediction modeling process based on the first feature vector and the revenue prediction model.

4. The method of claim 3, further comprising performing a first training operation to train the revenue prediction model based on a first training data set that includes at least one of financial filings data for one or more publicly traded companies, annual revenue data for one or more foreign companies, annual revenue data for one or more non-publicly traded companies, and a percentage of employees per type of employee that are employed by the one or more publicly traded companies, the one or more foreign companies, or the one or more non-publicly traded companies.

5. The method of claim 1, further comprising:
computing a revenue value for the company based on the revenue-per-employee value and a number of employees of the company, the revenue value representing a predicted revenue amount for the company for the period of time; and
causing presentation of the revenue value for the company and a reference to the company in the user interface of the device.

6. The method of claim 1, wherein the financial data includes at least one of publicly available financial information pertaining to the company, and proprietary information pertaining to one or more transactions between the company and the social networking service.

7. The method of claim 1, wherein the member data includes at least one of a name of a member of the social networking service, a gender, an age, a current job title, a previous job title, a name of a current employer, a name of a previous employer, a location, an industry, an identifier of an education institution, an identifier of employment experience, a skill, an identifier of a group, and an identifier of a member connection.

8. The method of claim 1, further comprising:
accessing a second set of data including a value indicating a digital marketing skill level associated with the members that are marketing employees of the company, and member activity and behavior data associated with the one or more members maintained by the social networking service; and
performing an advertising spend prediction modeling process based on the revenue-per-employee value, the second set of data, and an advertising spend prediction model, to generate an advertising-per-employee value that represents a predicted online advertising spending amount per employee of the company in the period of time.

9. The method of claim 8, further comprising generating a second feature vector based on the first set of data, the second set of data, and the revenue-per-employee value, and
wherein the performing of the advertising spend prediction modeling process based on the revenue-per-employee value, the second set of data, and the advertising spend prediction model includes performing the advertising spend prediction modeling process based on the second feature vector and the advertising spend prediction model.

10. The method of claim 9, further comprising performing a second training operation to train the advertising spend prediction model based on a second training data set that includes at least one of research data pertaining to online advertising amounts spent by one or more companies during a particular period of time, and social networking engagement data that identifies levels of engagement with the social networking service by the one or more companies.

11. The method of claim 8, further comprising:
computing an advertising spend value for the company based on the advertising-per-employee value and a number of employees of the company, the advertising spend value representing a predicted online advertising amount to be spent by the company in the period of time; and
causing presentation of the advertising spend value for the company and a reference to the company in the user interface of the device.

12. The method of claim 8, further comprising:
accessing sales data associated with the company maintained by the social networking service; and
performing a share prediction modeling process based on the advertising-per-employee value, the sales data, and a share prediction model, to generate a sales-per-employee value that represents a predicted share of the advertising-per-employee value to be spent by the company on a marketing product or service provided by the social networking service in the period of time.

13. The method of claim 12, further comprising generating a third feature vector based on the first set of data, the second set of data, the sales data, the revenue-per-employee value, and the advertising-per-employee value, and
wherein the performing of the share prediction modeling process based on the advertising-per-employee value, the sales data, and the share prediction model includes performing the share prediction modeling process based on the third feature vector and the share prediction model.

14. The method of claim 12, further comprising performing a third training operation to train the share prediction model based on a third training data set that includes sales opportunity history data for one or more companies identified as accounts in a Customer Relationship Management (CRM) system associated with the social networking service.

15. The method of claim 12, further comprising computing a predicted sales value for the company based on the sales-per-employee value and a number of employees of the company, the predicted sales value representing a predicted share of an online advertising amount to be spent by the company on the marketing product or service provided by the social networking service in the period of time.

16. The method of claim 15, further comprising ranking a plurality of company identifiers that each identifies one of a plurality of companies, based on a plurality of predicted sales values corresponding to the plurality of companies, the plurality of company identifiers including a company identifier that identifies the company, and the plurality of predicted sales values including the predicted sales value corresponding to the company.

17. The method of claim 16, further comprising causing presentation of the ranked plurality of company identifiers and the plurality of predicted sales values corresponding to the plurality of companies in the user interface of the device.

18. The method of claim 15, further comprising:
determining that one or more predicted sales values corresponding to one or more companies exceed a threshold value, the one or more companies including the company;
generating a lead recommendation that indicates that the one or more companies are associated with predicted sales values that exceed the threshold value; and
causing presentation of the lead recommendation in the user interface of the device.

19. A system comprising:
a memory for storing instructions;
a hardware processor, which, when executing the instructions, causes the system to:
access a first set of data including financial data associated with a company, member data associated with one or more members of a social networking service that are employees of the company, and an indicator of a marketing sophistication level associated with the company;
perform a revenue prediction modeling process based on the first set of data and a revenue prediction model, to generate a revenue-per-employee value that represents a predicted revenue amount per employee of the company for a period of time;
access a second set of data including a value indicating a marketing skill level associated with the members that are marketing employees of the company, and member activity and behavior data associated with the one or more members, maintained by the social networking service;
perform an advertising spend prediction modeling process based on the first set of data, the second set of data, and an advertising spend prediction model, to generate an advertising-per-employee value that represents a predicted online advertising spending amount per employee of the company in the period of time;
access sales data associated with the company, maintained by the social networking service; and
perform a share prediction modeling process based on the first set of data, the second set of data, the sales data, and a share prediction model, to generate a sales-per-employee value that represents a predicted share of the advertising-per-employee value to be spent by the company on a marketing product or service provided by the social networking service, in the period of time.

20. A non-transitory machine-readable storage medium comprising instructions that, when executed by one or more processors of a machine, cause the machine to perform operations comprising:
accessing a first set of data including financial data associated with a company, member data associated with one or more members of a social networking service that are employees of the company, and an indicator of a marketing sophistication level associated with the company;
performing a revenue prediction modeling process based on the first set of data and a revenue prediction model, to generate a revenue-per-employee value that represents a predicted revenue amount per employee of the company for a period of time;
accessing a second set of data including a value indicating a marketing skill level associated with the members that are marketing employees of the company, and member activity and behavior data associated with the one or more members, maintained by the social networking service;
performing an advertising spend prediction modeling process based on the first set of data, the second set of data, and an advertising spend prediction model, to generate an advertising-per-employee value that represents a predicted online advertising spending amount per employee of the company in the period of time;
accessing sales data associated with the company, maintained by the social networking service; and
performing, using one or more hardware processors, a share prediction modeling process based on the first set of data, the second set of data, the sales data, and a share prediction model, to generate a sales-per-employee value that represents a predicted share of the advertising-per-employee value to be spent by the company on a marketing product or service provided by the social networking service, in the period of time.
